(19) United States
(12) Patent Application Publication
(10) Pub. No.: US 2022/0399816 A1
(43) Pub. Date: Dec. 15, 2022

(54) Isolated Discontinuous Current Mode and Boundary Current Mode Buck Converters

(71) Applicant: Apple Inc., Cupertino, CA (US)

(72) Inventor: Vijay G. Phadke, San Jose, CA (US)

(21) Appl. No.: 17/343,460

(22) Filed: Jun. 9, 2021

(51) Int. Cl. H02M 3/335; H02M 1/00; H02M 1/08

(52) U.S. Cl. CPC H02M 3/335; H02M 1/0058; H02M 1/083

(57) ABSTRACT

Isolated buck converters can be an efficient solution in applications that deal with wide variations in input and/or output voltage. The double ended embodiments of such converters can also offer improved transformer utilization. Such converters can be operated in fixed frequency DCM mode operation or variable frequency boundary conduction mode (BCM). The buck/energy storage inductor may be placed in series with primary or secondary winding of the isolation transformer The inherent leakage inductance of the isolation transformer may also utilized as part of the buck inductance. If the leakage inductance of the isolation transformer is sufficiently high (such as in wireless power transfer applications), such converters can use the leakage inductance as the buck inductor.

### BACKGROUND

Buck-derived isolated converters, such as forward converters or half bridge/full bridge converters, may be considered to operate as controlled current sources. In such converters, the inductor current may be controlled by duty cycle control or peak current mode control to regulate the average voltage appearing across the output/load. The phase-shifted full bridge converter is an advanced version of an isolated buck-derived convertor that achieves Zero Voltage Switching (ZVS) of the control switches for lower turn on losses. Traditional phase shifted full bridge converters may be used in high power applications, and several off-the-shelf control ICs (such as UCC28950, LM5046, etc.) are available on the market. This traditional architecture uses an inductor on the secondary side of the isolation transformer and may be well suited for continuous current mode (CCM) operation at higher powers. Such converters may also require substantially higher voltage ratings for the output rectifiers.

### SUMMARY

Thus, what is needed in the art is an isolated buck-derived converter that improves on the afore-mentioned and other limitations of existing buck-derived isolated converters. For example, a converter that can provide significantly higher efficiency at low to medium power levels would be advantageous. Additionally, such improved buck-derived isolated converters may have simplified control arrangements and superior performance relative to converters such as LLC resonant converters when operated over a wide range of input and output voltage settings.

An isolated buck converter can include an isolation transformer that provides galvanic isolation between a power converter input and a power converter output, the isolation transformer having a primary winding and a secondary winding. The converter can further include a rectifier device coupled between the secondary winding and the power converter output. The converter can further include an inductance coupled in series with one of the primary winding or the secondary winding of the isolation transformer. The converter can further include first and second switching devices, wherein the first switching device can be coupled between a first terminal of the power converter input and a first terminal of the primary winding, and the second switching device can be coupled between a second terminal of the power converter input and a second terminal of the primary winding. The converter can further include first and second rectifier devices, wherein the first rectifier device corresponds to the first switching device and can be coupled between the first terminal of the power converter input and the second terminal of the primary winding, and the second rectifier device corresponds to the second switching device and can be coupled between the second terminal of the power converter input and the first terminal of the primary winding. The inductance coupled in series with one of the primary winding or the secondary winding of the isolation transformer can include a discrete inductor in series with the primary winding or the secondary winding. Additionally or alternatively, the inductance coupled in series with one of the primary winding or the secondary winding of the isolation transformer can include a leakage inductance of the isolation transformer. The first and second rectifier devices can be diodes.

The converter can further include a control circuit that operates the first and second switching devices to deliver a regulated output voltage to the power converter output. The control circuit can operate the first and second switching devices to deliver a regulated output voltage to the power converter output by turning on the first and second switching devices, turning off one of the first or second switching devices when the current through the inductance reaches a peak value corresponding to the regulated output voltage, subsequently turning off the other of the first or second switching devices, and after a delay, turning on the first and second switching devices to start a subsequent switching cycle. The control circuit can turn off the other of the first or second switching devices after a time corresponding to a fixed switching frequency. The control circuit can turn off the other of the first or second switching devices when the current through the secondary winding reaches zero. The delay can correspond to a demagnetization time of the isolation transformer. The duration of the delay can be determined by the control circuit detecting a zero of the primary current.

An isolated buck converter can include an isolation transformer that provides galvanic isolation between a power converter input and a power converter output, the isolation transformer having a primary winding and at least one secondary winding. The converter can also include at least one rectifier device coupled between the at least one secondary winding and the power converter output. The converter can also include an inductance coupled in series with one of the primary winding or the at least one secondary winding of the isolation transformer. The converter can also include first, second, third, and fourth switching devices. The first switching device can be coupled between a first terminal of the power converter input and a first terminal of the primary winding. The second switching device can correspond to the first switching device and can be coupled between a second terminal of the power converter input and a second terminal of the primary winding. The third switching device can be coupled between the first terminal of the power converter input and the second terminal of the primary winding. The fourth switching device can correspond to the third switching device and can be coupled between the second terminal of the power converter input and the first terminal of the primary winding.

In the above-described converter, the inductance coupled in series with one of the primary winding or the at least one secondary winding of the isolation transformer can be a discrete inductor in series with the primary winding, a discrete inductor in series with the at least one secondary winding, and/or a leakage inductance of the isolation transformer. The at least one secondary winding can be a center-tapped secondary winding.

The above-described converter can also include a control circuit that operates the first, second, third, and fourth switching devices to deliver a regulated output voltage to the power converter output. The control circuit can operate the first, second, third, and fourth switching devices to deliver a regulated output voltage to the power converter output by:
turning on the first and second switching devices to start a first half of the switching cycle, thereby causing current flow through the primary winding in a first direction;
turning off the first switching device when the current through the inductance reaches a peak value in the first direction, the peak value corresponding to the regulated output voltage;
subsequently turning off the second switching device;
turning on the third and fourth switching devices to start a second half of the switching cycle, thereby causing current flow through the primary winding in a second direction opposite the first direction;
turning off the fourth switching device when the current through the inductance reaches a peak value in the second direction, the peak value corresponding to the regulated output voltage;
subsequently turning off the third switching device; and
turning on the first and second switching devices to start a subsequent switching cycle.
   The control circuit can turn off the second and fourth switching devices after a time corresponding to a fixed switching frequency. The control circuit can turn off the second and fourth switching devices when the current through the at least one secondary winding reaches zero.

A control circuit for an isolated buck converter can include an input configured to receive a signal corresponding to an output voltage of the converter; an output regulation loop that receives the signal corresponding to the output voltage of the converter and generate a control signal; and a switch control generation block that generates drive signals for a plurality of switching devices of the converter. The switch control generation block generates drive signals that turn on first and second switching devices of the plurality of switching devices, turn off the first switching device when a current through an inductance of the isolated buck converter reaches a peak value corresponding to a regulated output voltage, and subsequently turn off the second switching device. The control circuit can turn off the second switching devices after a time corresponding to a fixed switching frequency. The control circuit can further include an input configured to receive a signal corresponding to a current through a secondary winding of an isolation transformer of the converter. The switch control generation block can generate drive signals that turn off the second switching devices when the current through the secondary winding reaches zero. The switch control generation block can also generate further drive signals that turn on third and fourth switching devices of the plurality of switching devices, turn off the fourth switching device when a current through an inductance of the isolated buck converter reaches a negative peak value corresponding to a regulated output voltage, and subsequently turn off the third switching device. The control circuit can turn off the second and fourth switching devices after times corresponding to a fixed switching frequency. The control circuit can further include an input configured to receive a signal corresponding to a current through a secondary winding of an isolation transformer of the converter, wherein the switch control generation block generates drive signals that turn off the second and fourth switching devices when the current through the secondary winding reaches zero.

### BRIEF DESCRIPTION OF THE DRAWINGS

FIG. 1 illustrates an exemplary buck converter.

FIG. 2 illustrates various operating waveforms of a buck converter according to FIG. 1.

FIG. 3 illustrates various operating waveforms of a buck converter according to FIG. 1 in the boundary conduction mode.

FIG. 4 illustrates a schematic diagram of a single-ended, two-switch, buck-derived, isolated forward converter.

FIG. 5 illustrates certain switching waveforms of the converter depicted in FIG. 4.

FIG. 6 shows the same switching waveforms as FIG. 5, enlarged for better readability

FIG. 7 shows an alternative embodiment of the converter of FIG. 4, in which the buck/energy storage inductor is relocated to the secondary side of the isolation transformer.

FIG. 8 illustrates a schematic diagram of a double-ended, four-switch, buck-derived, isolated forward converter.

FIG. 9 illustrates certain switching waveforms of the converter depicted in FIG. 8.

FIG. 10 shows the same switching waveforms as FIG. 9, enlarged for better readability.

FIG. 11 shows an alternative embodiment of the converter of FIG. 8, in which the buck/energy storage inductor is relocated to the secondary side of the isolation transformer.

FIG. 12 illustrates a block diagram of a control circuit for the converters described herein.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth in order to provide a thorough understanding of the implementations described herein. In other instances, methods, procedures and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

Buck converters may be used when a voltage source needs to be reduced to a lower voltage or “stepped down.” Buck converters can operate in three modes, characterized by the current that flows through the buck inductor. In the discontinuous conduction mode (DCM) the current through the inductor is periodically at zero for some period of time. In continuous conduction mode (CCM), the current through the inductor consistently remains at a non-zero value. In the boundary conduction mode, which typically involves a variable switching frequency, the inductor current may reach zero only briefly during the switching cycle. System designers may choose DCM or boundary mode operation when turn on losses are an issue because of speed of the freewheeling rectifier. This condition is often encountered in high voltage application.

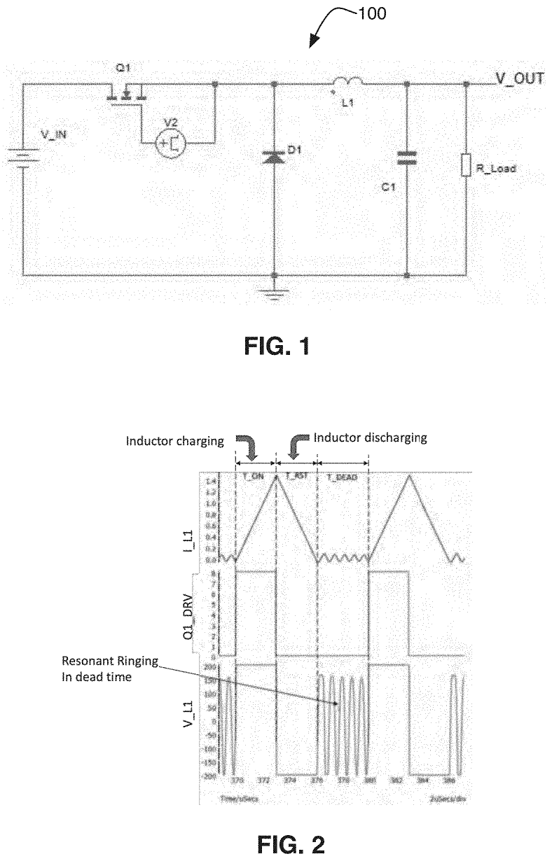

FIG. 1 shows a schematic diagram of an exemplary buck converter 100. Switch Q1 is the control switch of the buck converter, inductor L1 is the energy storage or buck inductor, diode D1 is a freewheeling rectifier, and capacitor C1 is the output filter capacitor. FIG. 2 illustrates plots of various waveforms that show operation of a DCM buck converter. More specifically, V_L1 is the voltage across inductor L1, Q1_DRV is the gate drive signal applied between gate and source of Q1 (identified as V2 in FIG. 1), and I_L1 is the current flowing through inductor L1. When switch Q1 is ON during time period T_ON, current I_L1 ramps up through inductor L1 (in the output capacitor and load). This period may be called the “charging period” of the inductor (because energy is stored in the inductor during this period), denoted as T_ON. When switch Q1 turns OFF, the inductor current I_L1 ramps down, flowing through output capacitor C1, load R_Load, and freewheeling rectifier diode D1. This period may be called the “discharging period” or “reset period” of the inductor, denoted T_RST. After inductor L1 is discharged, no current flows through the inductor except parasitic ringing until the next operation of switch Q1. This time period may be called the Dead Time, denoted T_DEAD.

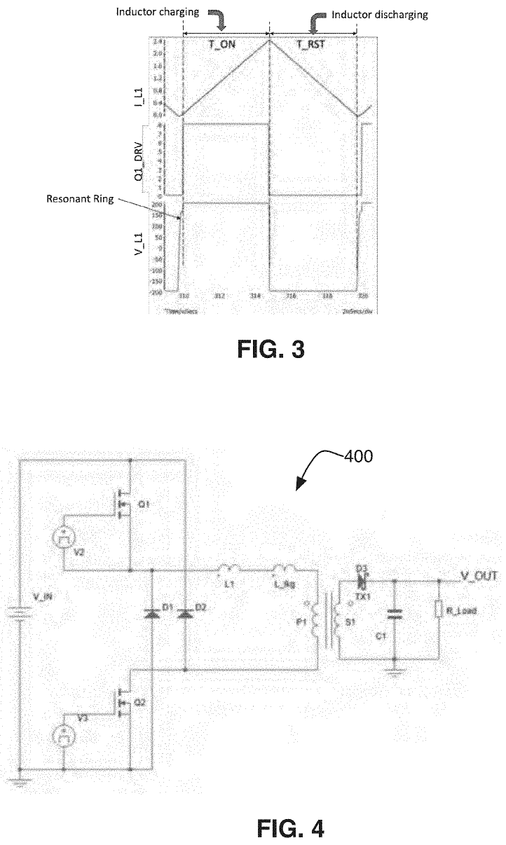

If switch Q1 is turned on as soon as inductor current I_L1 ramps down to zero, without waiting for a fixed time period to expire, the converter operates in a variable frequency boundary conduction mode. In this mode, the switching frequency increases as the output power reduces. The switching frequency also increases as the input voltage increases. In some applications, this operating mode may preferred because it can result in lower peak currents. It may also be possible to reduce capacitive losses at turn on, if switch Q1 can be turned on at the valley of the ringing. Turning switch Q1 on at the valley of the first ring can result in boundary mode operation with large frequency variation as a function of input voltage and output load. Conversely, turning switch Q1 on at the valley of any subsequent ring can cause minimal frequency variation. FIG. 3 further illustrates waveforms illustrating operation of the buck converter of FIG. 1 in boundary mode, which include the charging period T_ON and the discharging period T_RST, but omit the fixed dead time T_DEAD as described above.

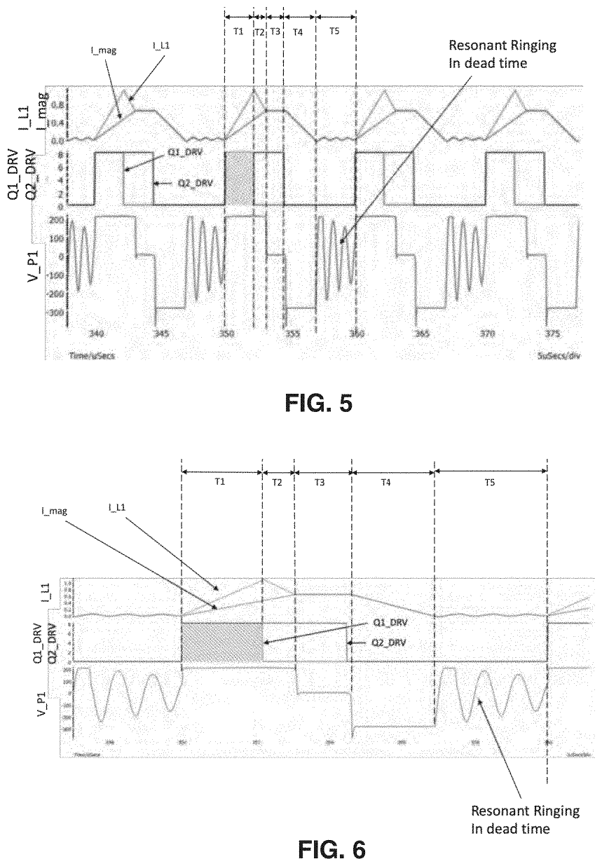

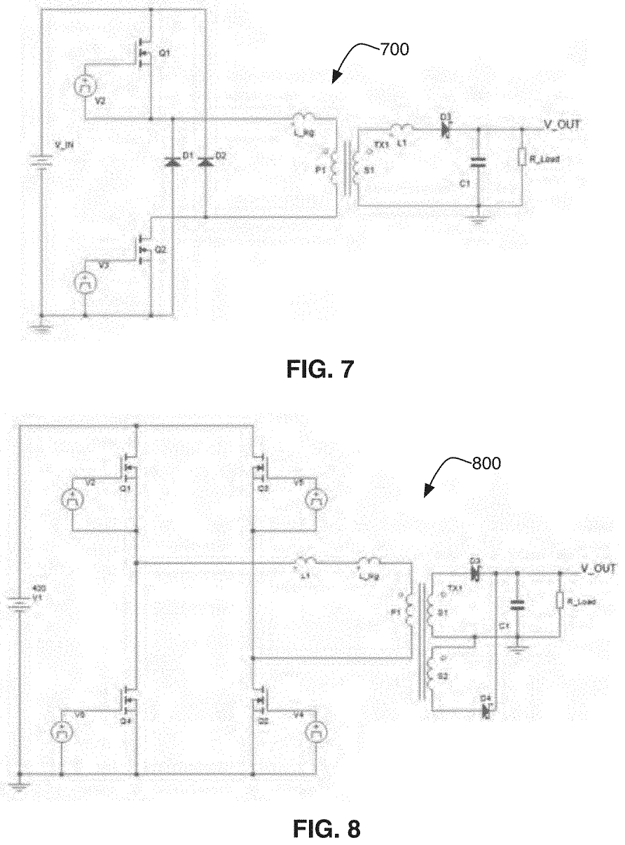

Described below are various isolated buck-derived power converters that can achieve the benefits of discontinuous current mode (DCM) buck converter in applications that require galvanic isolation between input and output. For understanding of the concept, a basic embodiment of a single ended DCM forward converter is discussed with reference to FIGS. 4-7. This example uses a two-switch forward converter. The schematic diagram in FIG. 4 shows the circuit arrangement of this basic embodiment. FIG. 5 shows certain switching waveforms of the converter depicted in FIG. 4. FIG. 6 shows the same switching waveforms as FIG. 5, enlarged for better readability. FIG. 7 shows an alternative embodiment of the converter of FIG. 4, in which the buck/energy storage inductor L1 is relocated to the secondary side of the isolation transformer.

The two-switch, buck-derived, isolated forward converter 400 of FIG. 4 receives at its input a DC input voltage V_IN. This input voltage may be selectively coupled to energy storage/buck inductor L1 by switches Q1 and Q2, with the current path alternately completed by diodes D1, D2, as described in greater detail below. In the embodiments discussed herein, the switching devices are illustrated as metal oxide semiconductor field effect transistors (MOSFETs), but other switching device types could also be used as appropriate for a given application. Energy storage/buck converter is coupled in series with the primary winding P1 of an isolation transformer that provides galvanic isolation between the input and output of converter 400. The isolation transformer also includes an inherent leakage inductance L_lkg depicted as being in series between boost/energy storage inductor L1 and primary winding P1; however, this is not a discrete component, but rather an inherent characteristic of the transformer itself. The secondary winding S1 of the isolation transformer is coupled to a rectifier diode D3, output filter capacitor C1, and the output load, depicted by resistor R_load. Rectifier diode D3 is depicted as a Schottky diode, but other rectifier types including conventional diodes, controlled rectifiers, etc. could also be used depending on the requirements of a particular application.

Turning now to FIGS. 5 and 6, waveform V_P1 is the voltage across the primary winding P1. Q1_DRV is the voltage drive signal applied between gate and source of Q1 (depicted as V2 in FIG. 4). Q2_DRV is the voltage drive signal applied between gate and source of Q2 (depicted as V3 in FIG. 4). Finally, I_L1 is the current flowing in buck/energy storage inductor L1. For simplicity, it is assumed that the converter is operating in steady state with output voltage V_OUT regulated at the desired output voltage level and is providing fixed power to R_Load. Because the leakage inductance (L_lkg) of the isolation transformer is very small as compared to value of buck/energy storage inductor L1, it may be considered as a part of L1 for all practical purposes.

When current is flowing in the secondary winding S1, through rectifier D3, the output voltage V_OUT is reflected across the primary winding P1 based on the transformer turns ratio. In other words, during conduction of D3, Vp1=(Np÷Ns)×(V_OUT+VF_D3), where Np is number of primary turns of the isolation transformer, Ns is the number of secondary turns of the isolation transformer, and VF_D3 is the instantaneous forward voltage drop across the rectifier diode D3. Additionally, the voltage drop across inductor L1 during its energization is V_L1=V_IN−Vp1, and the voltage across inductor L1 during its demagnetization is −Vp1. The steady state operation of converter 400 shown in FIG. 4 as illustrated in FIGS. 5 & 6 is as follows:

Time interval T1: To initiate time interval T1, the control circuit turns ON switches Q1 and Q2, causing the current through inductor L1 (I_L1) and transformer primary winding P1 to ramp up. The voltage impressed across buck/energy storage inductor L1, is V_L1=V_IN−Vp1, which causes the current ramp up. By design (i.e., by selection of the inductance value of inductor L1), the current ramp rate of inductor L1 is higher than the ramp rate of the transformer magnetizing current (I_mag). The difference in ramp rate is reflected on the secondary side as a function of the turns ratio of the isolation transformer. When the primary current reaches a peak value set by the control circuit (for example, by peak current command or on-time command) switch Q1 is turned off by the control circuit, ending time interval T1.

Time interval T2: To initiate time interval T2, the control circuit turns off switch Q1. As switch Q1 is turned off, and switch Q2 remains on, the source node of switch Q1 falls below ground until it is clamped by the forward voltage drop of diode D1. The buck/energy storage inductor current I_L1 ramps down in L1 while freewheeling through switch Q2 and diode D1. However, magnetizing current I_mag in transformer primary winding P1 continues to rise because the reflected output voltage is still impressed across it. During time interval T2, a voltage of −Vp1 is applied across buck/energy storage inductor L1. Time interval T2 ends when the decreasing inductor current I_L1 decreases to the value of transformer magnetizing current I_mag.

Time interval T3: Time interval T3 begins at the end of time interval T2, i.e., when the decreasing inductor current I_L1 decreases to the value of transformer magnetizing current I_mag. Because the buck/energy storage inductor current I_L1 equals the magnetizing current I_mag, the transformer secondary current (i.e., the current through secondary winding S1) has dropped to zero. The current in inductor L1 and transformer winding P1 remains substantially flat while freewheeling through switch Q2 and diode D1. This current may fall slightly as a result of circulating losses in the freewheeling path. Time interval T3 ends when the control circuit turns off switch Q2, the timing of which is discussed in greater detail below.

Time interval T4: Time interval T4 begins when the control circuit turns off switch Q2. When switch Q2 turns off, the voltage at its drain terminal rises until the forward voltage drop of diode D2 clamps it to the input voltage V_IN. The voltage across the series combination of inductor L1 and transformer primary winding P1 reverses, and the transformer demagnetizes, along with inductor L1, for the remainder of time interval T4. The substantially complete demagnetization of the isolation transformer, indicated by I_L1 reaching zero, marks the end of time period T4.

Time interval T5: Time interval T5 begins when the transformer is substantially completely demagnetized, which, as noted above, is indicated by current I_L1 reaching zero. During time interval T5, parasitic ringing may be observed during the dead time before the next switching cycle begins with the control circuit turning on switches Q1 and Q2, starting the next instance of time interval T1.

The operating sequence described above is based on fixed frequency operation. In other words, the switching events occur at fixed timings depending on the fixed frequency of operation. In fixed frequency operation, the only real purpose of time interval T3 is waiting for the expiry of the set time period dictated by the switching frequency. However, the control circuit can detect the instant when secondary current falls to zero at the end of time interval T2. Any of a variety zero current detection (ZCD) techniques may be used for this purpose. Thus, rather than waiting a fixed time after the turn off of switch Q1 to turn off switch Q2, the control circuit can instead turn switch Q2 off immediately upon detecting the zero current on the secondary, thus immediately initiating the transformer reset action. This substantially eliminates time interval T3, avoiding extended freewheeling of current I_L1 through inductor L1 and primary winding P1, reducing the associated power losses. Additionally, the control circuit can also detect the demagnetization of the transformer, i.e., when the parasitic ringing in time interval T5 starts. For example, this can occur by detecting that current I_L1 reaches zero. The next switching cycle (i.e., returning to time interval T1) may be triggered upon detecting transformer demagnetization while suspending the dead time. This control technique can result in variable frequency/boundary conduction mode operation of the converter 400. All the principles discussed above are still applied for such boundary mode operation of converter 400.

Depending on the particular requirements of a given implementation, either fixed frequency mode or variable frequency/boundary conduction mode operation may be selected. Additionally, the functional operation of switches Q1 and Q2 can be interchanged. In other words, switch Q2 can be turned off instead of switch Q1 when the peak current in through inductor L1 reaches the desired value set as reference or when the on time set by control circuit expires. Switch Q1 then remains on, and inductor current I_L1 freewheels through primary winding P1 and diode D2. Otherwise, operation of the circuit is as described above. Additionally, it is also possible to place the buck/energy storage inductor L1 on the secondary side of the circuit and still operate and obtain the benefits described above. Such a converter 700 is illustrated in FIG. 7, which is substantially identical to converter 400 illustrated in FIG. 4, except that energy storage/buck inductor L1 has been relocated to the secondary side of the isolation transformer, being positioned in series with the secondary winding S1 and the rectifier D3.

A single ended forward converter as described above with reference to FIGS. 4-7 does not use the transformer flux swing in both directions. Thus, the magnetic elements of the circuit are underutilized. This can be addressed by a double-ended embodiment of the converter that uses the transformer flux swing in all four quadrants. One embodiment of such a converter is illustrated in FIG. 8. Converter 800 of FIG. 8 may be thought of as using the architecture of FIG. 4 in interleaved manner. There are two power rails, controlled by switches Q1-Q4 such that they operate 180 degrees out of phase. As a result, the current in the isolation transformer primary winding P1 and buck/energy storage inductor L1 is bidirectional. Two transformer secondary windings S1, S2 are used to deliver power to the output in respective half cycles. Otherwise, the basic principles of operation remain the same as discussed above with respect to FIGS. 4-7.

It is noted that the illustrated MOSFET switches have an intrinsic body diode across their drain-source nodes. Thus switching devices Q1 and Q2 along with the intrinsic body diodes of devices Q3 and Q4 perform the same function as switches Q1 and Q2 and diodes D1 and D2 as discussed above with respect to FIG. 4 in one half of the cycle. In the other half of the cycle, devices Q3 and Q4 along with the intrinsic body diodes of Q1 and Q2 repeat the same operation in opposite direction. Thus, converter 800 is effectively two switching stages as in FIG. 4 that use a common transformer and inductor, but operate 180 degrees out of phase. On the secondary side, the converter can include either a center-tapped secondary with full wave rectification (as illustrated) or a single secondary with a full-bridge rectifier (not shown).

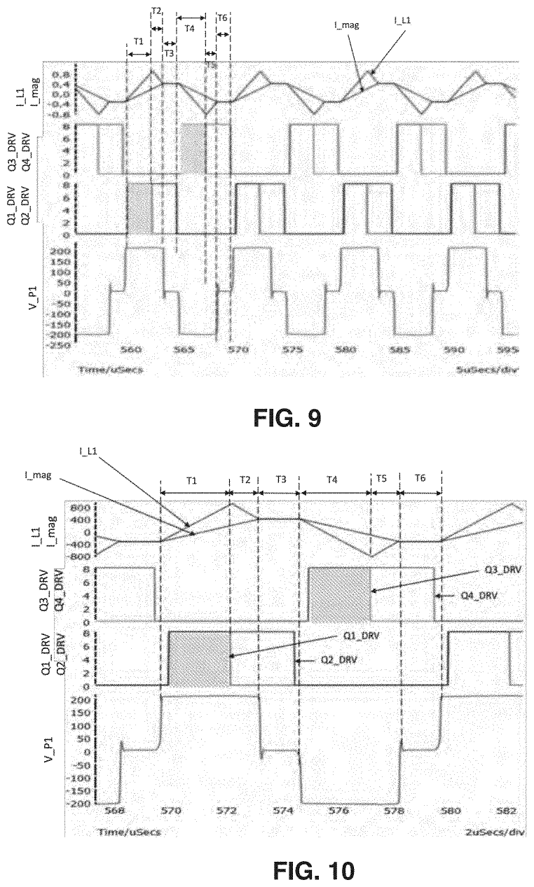

FIG. 9 shows the switching waveforms of the converter in steady state; and FIG. 10 shows the same waveforms as FIG. 9 enlarged to focus on fewer switching cycles for improved readability. Additionally, because the leakage inductance of the transformer is very small as compared to the inductance value of inductor L1, it (the leakage inductance) may be considered as part of inductor L1 for all practical purposes. Operation of converter 800 illustrated in FIG. 8 (with reference to the waveforms shown in FIG. 10) is as follows:

Time interval T1: Time interval T1 is initiated by the control circuit turning on switches Q1 and Q2. As a result, the current I_L1 flowing through inductor L1 and transformer primary winding P1 ramps up in positive direction until it reaches the peak value set by the control circuit for output regulation. At the same time, magnetizing current I_mag builds up in the primary but at lower slew rate than the inductor current. As discussed above, this is by design and is caused by selection of the inductance value of inductor L1. The difference between the I_L1 current and the I_mag magnetizing current reflects on the secondary based on turns ratio of the transformer. Power is delivered to the output through rectifier diode D3, which is forward biased. Current continues to ramp up in inductor L1 until the control circuit turns off switch Q1 at the end of interval T1. (As noted above, this is triggered by the peak current target of the control circuit to achieve output regulation.).

Time interval T2: Time interval T2 begins when the control circuit turns off switch Q1. When switch Q1 turns off, it's source node voltage falls towards ground until it is clamped by the intrinsic body diode of switch Q4. Now inductor current I_L1 freewheels through the primary winding P1, switch Q2, and the body diode of Q4. Inductor current I_L1 starts to ramp down; however, the magnetizing current I_mag continues to ramp up because there is still reflected output voltage impressed upon the primary winding P1 while output rectifier D3 is conducting. When the inductor current I_L1 equals the magnetizing current I_mag, the secondary current drops to zero. This is the end of period T2 (which can be detected by the control circuit as the secondary current reaching zero).

Time interval T3: The I_L1 current flowing through inductor L1 and the magnetizing current I_mag in transformer primary winding P1 continues to freewheel through switch Q2 and the body diode of switch Q4 at a roughly constant value. This current amplitude drops slightly due to conduction losses in the circuit elements along the current path. Time interval T3 continues until half of the switching period is over (for fixed frequency operation). Time intervals T1, T2, and T3 thus constitute the first half of the switching period. As discussed above, and in greater detail below, time interval T3 may be substantially eliminated to allow for variable frequency boundary mode operation.

Time interval T4: In the second half cycle, the control circuit turns on switches Q3 and Q4 to begin time interval T4. As a result, current starts to ramp up in inductor L1 and primary winding P1 in the opposite/negative direction. Magnetizing current I_mag in the transformer likewise ramps from a positive value to a negative value, exploiting the other two quadrants of the transformer's magnetic core. Now rectifier diode D4 connected to the secondary winding S2 is forward biased and starts to deliver power to the output. As a result, a voltage having the same magnitude but opposite polarity as in time interval T1 is impressed on the primary winding. When the inductor current I_L1 reaches the target peak value set by the control circuit, the control circuit turns off switch Q4, ending time interval T4.

Time interval T5: When the control circuit turns off switch Q4, time interval T5 begins. The drain node voltage of switch Q4 rises towards the input voltage V1 until it is clamped by the intrinsic body diode of switch Q1. At that point, inductor current I_L1 freewheels through switch Q3 (which is still turned on), the primary winding P1, and the body diode of switch Q1. Inductor current I_L1 starts to ramp down; however, the magnetizing current I_mag continues to ramp up because there is still reflected output voltage impressed on the primary winding P1 so long as output rectifier D4 is conducting. When the current in inductor L1 (I_L1) equals the magnetizing current (I_mag), the secondary current drops to zero (which can be detected by the control circuit), ending time interval T5.

Time interval T6: In time interval T6, the inductor current I_L1 flowing through inductor L1 and the magnetizing current I_mag flowing through primary winding P1 continues to freewheel through switch Q3 and body diode of switch Q1 at a roughly fixed value. This current amplitude may drop slightly due to conduction losses in various series elements in the circuit path. Time interval T6 continues until the switching period is over (for fixed frequency operation). Time intervals T4, T5 and T6 thus constitute the second half of the switching period. As discussed above, and in greater detail below, time interval T6 may be substantially eliminated to allow for variable frequency boundary mode operation.

Further, when the body diodes of all four switches Q1-Q4 conduct for clamping purposes as described above, the control circuit may turn on the respective switches by supplying a positive gate drive voltage. This effectively makes the clamp diodes work as synchronous rectifiers, reducing circulating losses. Additionally, by turning on the switches while their body diodes are conducting, zero voltage switching (ZVS) is achieved, reducing switching losses. Thus, effectively, each of the four switches Q1-Q4 partly operate as synchronous rectifiers (when current is flowing from source to drain) and partly operate as power control switches (when current flows from drain to source). Each switch operates at approximately 50% duty cycle. In practice, a short dead time may be introduced between operation of the upper and lower switches in each limb of the circuit to avoid current shoot through and achieve a proper voltage transition.

In addition to the considerations described above, the transformer magnetizing inductance may be tuned such that there is always adequate energy in inductor L1 and the magnetizing inductance to achieve zero voltage switching (ZVS) operation of switches Q1-Q4 in the power control mode (as opposed to the synchronous rectifier/clamping mode, which achieves ZVS as described above). For example, the transformer magnetizing inductance may be controlled by introducing a suitable air gap into the magnetic core of the transformer. More specifically, when the operation changes from power control switching to freewheeling, the peak current in inductor L1 is higher and ZVS operation is easy to achieve. However, when the next half cycle starts, the current in inductor L1 and primary winding P1 is substantially zero, and ZVS operation may not be achieved. This requirement can be addressed by controlling minimum magnetizing current down to lower power level by appropriately designing the magnetizing inductance.

As with time interval T3 for the single-ended converter of FIGS. 4-7, in the double-ended converter of FIG. 8, time intervals T3 and T6 of the switching sequence described with reference to FIG. 10 serve no purpose other than waiting for the expiry of the half period set by the control for fixed frequency operation. It is thus possible to eliminate time periods T3 and T6 by starting the next half cycle as soon as current in inductor L1 equals the magnetizing current, i.e., as soon as the secondary current falls to zero. This results operation in variable frequency boundary mode operation. Otherwise, all of the principles discussed above still apply.

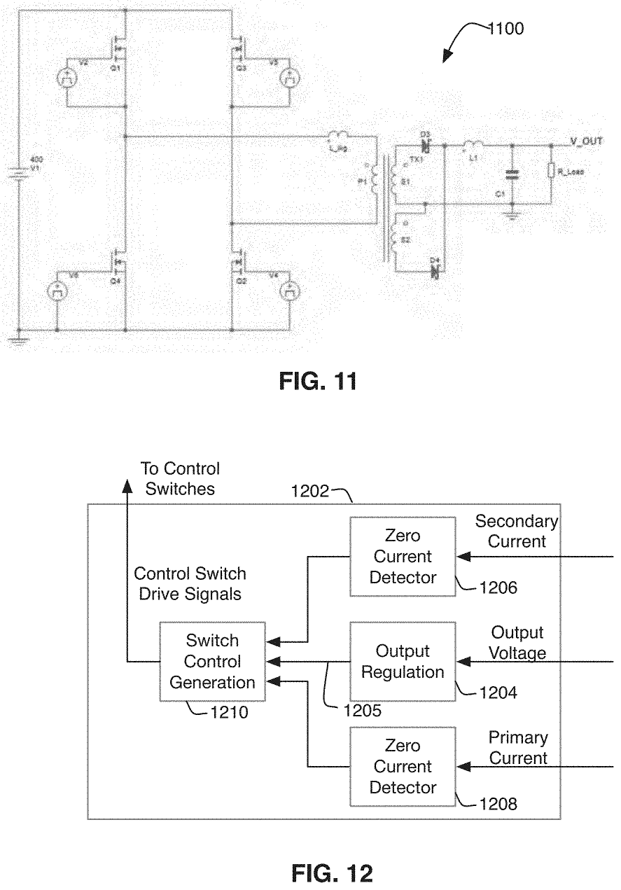

Depending on the particular requirements of a given implementation, either fixed frequency mode or variable frequency/boundary conduction mode operation may be selected. Additionally, the functional operation of switch pairs Q1/Q2 and Q3/Q4 can be interchanged. Additionally, it is also possible to place the buck/energy storage inductor L1 on the secondary side of the circuit and still operate and obtain the benefits described above. Such a converter 1100 is illustrated in FIG. 11, which is substantially identical to converter 800 illustrated in FIG. 8, except that energy storage/buck inductor L1 has been relocated to the secondary side of the isolation transformer, being positioned in series with the secondary winding S1/rectifier D3 and secondary winding S2/rectifier D4.

As described above, the transformer leakage inductance L_lkg is effectively added to the value of buck/energy storage inductor L1. Thus, in some embodiments, buck/energy storage inductor L1 may be integrated within the transformer structure. For example, the primary and secondary windings P1 and S1 may be wound with a lower coupling factor to obtain a desired leakage inductance. Additionally and/or alternatively, a split primary and secondary winding can also be used to increase leakage inductance, as is sometimes used in LLC resonant converters. In either case, the separate, discrete buck/energy storage inductor can be eliminated, or its inductance value (and thus physical size) can be reduced to save cost and space.

In addition to the foregoing, multiple instances of the converter configurations discussed above can be operated in parallel for higher power delivery, similar to multi-phase non-isolated buck converters. A phase shift of 180 degrees between the two converters results in two phase converter with ripple cancellation effect at output. Such N number of converters can be operated with phase shift of 360/N.

FIG. 12 illustrates a block diagram of an exemplary control circuit 1202 that may be used in connection with the converters described herein. Control circuit 1202 may receive a variety of input signals, including, for example, the output voltage, the secondary current (i.e., the current through the secondary winding(s) of the isolation transformer), and the primary current (i.e., the current through the primary winding of the isolation transformer). Not all embodiments require all three input signals. For example, fixed frequency embodiments may not require the secondary current input and the associated zero current detector 1206. Similarly, double ended embodiments may not require the primary current input and associated zero current detector 1208, used to detect demagnetization of the transformer.

In any case, the output voltage (or other value for which regulation is desired) may be input into an output regulation loop 1204. Output regulation loop 1204 that may generate a suitable control signal 1205 that may be used by switch control generation block 1210 to generate the drive signals for the respective switches. For example, as discussed above, control signal 1205 may correspond to a peak inductor current corresponding to a desired output voltage. This signal may be used by switch control generation block 1210 to determine the end of the T1 intervals discussed above. More specifically, control circuit 1202 may use this signal to determine when to turn off switch Q1 in the single-ended embodiment of FIGS. 4-7 or to determine the turn off time of switch Q1 in the first half period and the turn off time of switch Q4 in the second half period in the double-ended embodiment of FIGS. 8-11.

The secondary current may be supplied to a zero current detector 1206 that can generate a signal indicating that the secondary current has reached zero, allowing the control circuit to end/substantially eliminate time periods T3 and T6 as discussed with respect to the various embodiments above. Alternatively, for fixed frequency operation, this input may be omitted or ignored. Similarly, the primary current may be provided to a zero current detector 1208 that detects zero of the primary winding current, allowing control switch generation block 1210 to identify the end of time periods T5 in the single-ended embodiment discussed above.

In any case, switch control generation block 1210 may generate the gate drive signals for the control switches in the respective embodiments as described above. There may also be additional gate drive circuitry, such as level shifters or the like, as required for particular configurations. This additional gate drive circuitry can either be part of control circuit 1202 or can be implemented separately.

This converter circuits described herein may be particularly advantageous when used in connection with for inductive wireless power transfer applications. In such applications, the power transmitting (i.e., primary) winding and the power receiving (i.e., secondary) winding are loosely coupled by virtue of their arrangement. As a result, the leakage inductance of the resulting “transformer” is relatively high. This converter circuits described herein can be used with such arrangements to achieve high operating efficiency. Further, in many inductive wireless power application, the main objective is to charge a battery. The converters described herein may be particularly advantageous in battery charging applications because of the inherent transfer function of a buck converter. In other words, a buck converter is effectively a current source, and thus well-suited to battery charging applications.

To summarize, isolated buck converters have been described herein. Such converters can be an efficient solution in applications that deal with wide variations in input and/or output voltage. The double ended embodiments of such converters can offer improved transformer utilization.

These converters address many limitations of prior art converters, such as LLC converters, including operation over wide input voltage ranges or accommodating wide output voltage variations, while maintaining soft switching operation. Additionally, the proposed converters can be operated in fixed frequency DCM mode operation or variable frequency boundary conduction mode (BCM). The buck/energy storage inductor may be placed in series with primary winding of the isolation transformer or, if desired may be placed in series with the secondary winding(s) of the isolation transformer. The inherent leakage inductance of the isolation transformer may also utilized as part of the buck inductance for leakage energy recovery. In applications where the leakage inductance of the isolation transformer is very high due to design constraints (such as wireless power transfer applications), the converters described herein can use the leakage inductance itself as the buck inductor. Finally, because the topology is buck derived, it acts as a current source and may be particularly advantageous in battery charging applications.

The foregoing describes exemplary embodiments of isolated buck converters. Such converters may be used in a variety of applications but may be particularly advantageous when used in conjunction with battery powered personal electronic devices such as smartphones, smart watches, tablet computers, laptop computers, and associated accessories including those that rely on wireless or inductive power transfer. Additionally, although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

1. An isolated buck converter comprising:
an isolation transformer that provides galvanic isolation between a power converter input and a power converter output, the isolation transformer having a primary winding and a secondary winding;
a rectifier device coupled between the secondary winding and the power converter output;
an inductance coupled in series with one of the primary winding or the secondary winding of the isolation transformer;
first and second switching devices, wherein:
the first switching device is coupled between a first terminal of the power converter input and a first terminal of the primary winding; and
the second switching device is coupled between a second terminal of the power converter input and a second terminal of the primary winding; and
first and second rectifier devices, wherein:
the first rectifier device corresponds to the first switching device and is coupled between the first terminal of the power converter input and the second terminal of the primary winding; and
the second rectifier device corresponds to the second switching device and is coupled between the second terminal of the power converter input and the first terminal of the primary winding.

2. The isolated buck converter of claim 1 wherein the inductance coupled in series with one of the primary winding or the secondary winding of the isolation transformer is a discrete inductor in series with the primary winding.

3. The isolated buck converter of claim 1 wherein the inductance coupled in series with one of the primary winding or the secondary winding of the isolation transformer is a discrete inductor in series with the secondary winding.

4. The isolated buck converter of claim 1 wherein the inductance coupled in series with one of the primary winding or the secondary winding of the isolation transformer is a leakage inductance of the isolation transformer.

5. The isolated buck converter of claim 1 further comprising a control circuit that operates the first and second switching devices to deliver a regulated output voltage to the power converter output.

6. The isolated buck converter of claim 5 wherein the control circuit operates the first and second switching devices to deliver a regulated output voltage to the power converter output by:
turning on the first and second switching devices;
turning off one of the first or second switching devices when the current through the inductance reaches a peak value corresponding to the regulated output voltage;
subsequently turning off the other of the first or second switching devices; and
after a delay, turning on the first and second switching devices to start a subsequent switching cycle.

7. The isolated buck converter of claim 6 wherein the control circuit turns off the other of the first or second switching devices after a time corresponding to a fixed switching frequency.

8. The isolated buck converter of claim 6 wherein the control circuit turns off the other of the first or second switching devices when the current through the secondary winding reaches zero.

9. The isolated buck converter of claim 6 wherein the delay corresponds to a demagnetization time of the isolation transformer.

10. The isolated buck converter of claim 9 wherein the duration of the delay is determined by the control circuit detecting a zero of the primary current.

11. The isolated buck converter of claim 1 wherein the first and second rectifier devices are diodes.

12. An isolated buck converter comprising:
an isolation transformer that provides galvanic isolation between a power converter input and a power converter output, the isolation transformer having a primary winding and at least one secondary winding;
at least one rectifier device coupled between the at least one secondary winding and the power converter output;
an inductance coupled in series with one of the primary winding or the at least one secondary winding of the isolation transformer;
first, second, third, and fourth switching devices, wherein:
the first switching device is coupled between a first terminal of the power converter input and a first terminal of the primary winding;
the second switching device corresponds to the first switching device and is coupled between a second terminal of the power converter input and a second terminal of the primary winding;
the third switching device is coupled between the first terminal of the power converter input and the second terminal of the primary winding; and
the fourth switching device corresponds to the third switching device and is coupled between the second terminal of the power converter input and the first terminal of the primary winding.

13. The isolated buck converter of claim 12 wherein the inductance coupled in series with one of the primary winding or the at least one secondary winding of the isolation transformer is a discrete inductor in series with the primary winding.

14. The isolated buck converter of claim 12 wherein the inductance coupled in series with one of the primary winding or the at least one secondary winding of the isolation transformer is a discrete inductor in series with the at least one secondary winding.

15. The isolated buck converter of claim 12 wherein the inductance coupled in series with one of the primary winding or the at least one secondary winding of the isolation transformer is a leakage inductance of the isolation transformer.

16. The isolated buck converter of claim 12 wherein the at least one secondary winding is a center-tapped secondary winding.

17. The isolated buck converter of claim 12 further comprising a control circuit that operates the first, second, third, and fourth switching devices to deliver a regulated output voltage to the power converter output.

18. The isolated buck converter of claim 12 wherein the control circuit operates the first, second, third, and fourth switching devices to deliver a regulated output voltage to the power converter output by:
turning on the first and second switching devices to start a first half of the switching cycle, thereby causing current flow through the primary winding in a first direction;
turning off the first switching device when the current through the inductance reaches a peak value in the first direction, the peak value corresponding to the regulated output voltage;
subsequently turning off the second switching device;
turning on the third and fourth switching devices to start a second half of the switching cycle, thereby causing current flow through the primary winding in a second direction opposite the first direction;
turning off the fourth switching device when the current through the inductance reaches a peak value in the second direction, the peak value corresponding to the regulated output voltage;
subsequently turning off the third switching device; and
turning on the first and second switching devices to start a subsequent switching cycle.

19. The isolated buck converter of claim 18 wherein the control circuit turns off the second and fourth switching devices after a time corresponding to a fixed switching frequency.

20. The isolated buck converter of claim 18 wherein the control circuit turns off the second and fourth switching devices when the current through the at least one secondary winding reaches zero.

21. A control circuit for an isolated buck converter comprising:
an input configured to receive a signal corresponding to an output voltage of the converter;
an output regulation loop that receives the signal corresponding to the output voltage of the converter and generate a control signal; and
a switch control generation block that generates drive signals for a plurality of switching devices of the converter;
wherein the switch control generation block generates drive signals that:
turn on first and second switching devices of the plurality of switching devices;
turn off the first switching device when a current through an inductance of the isolated buck converter reaches a peak value corresponding to a regulated output voltage;
subsequently turn off the second switching device.

22. The control circuit of claim 21 wherein the controller turns off the second switching devices after a time corresponding to a fixed switching frequency.

23. The control circuit of claim 21 further comprising an input configured to receive a signal corresponding to a current through a secondary winding of an isolation transformer of the converter, wherein the switch control generation block generates drive signals that turn off the second switching devices when the current through the secondary winding reaches zero.

24. The control circuit of claim 21 wherein the switch control generation block generates further drive signals that:
turn on third and fourth switching devices of the plurality of switching devices;
turn off the fourth switching device when a current through an inductance of the isolated buck converter reaches a negative peak value corresponding to a regulated output voltage;
subsequently turn off the third switching device.

25. The control circuit of claim 24 wherein the control circuit turns off the second and fourth switching devices after times corresponding to a fixed switching frequency.

26. The control circuit of claim 24 further comprising an input configured to receive a signal corresponding to a current through a secondary winding of an isolation transformer of the converter, wherein the switch control generation block generates drive signals that turn off the second and fourth switching devices when the current through the secondary winding reaches zero.
